(19) United States
(12) Patent Application Publication
(10) Pub. No.: US 2005/0016069 A1
(43) Pub. Date: Jan. 27, 2005

(54) Housing for a window regulator actuating device

(76) Inventors: Jean-Pierre Doux, Jargeau (FR); Nicolas Galliot, Sully Sur Loire (FR); Stephane Hemond, Les Bordes (FR); Patrick Hurt, Bouzy La Foret (FR); Didier Michel, Saint-Pere (FR)

Correspondence Address: CARLSON, GASKEY & OLDS, P.C., 400 WEST MAPLE ROAD, SUITE 350, BIRMINGHAM, MI, 48009, US

(21) Appl. No.: 10/886,516

(22) Filed: Jul. 7, 2004

(30) Foreign Application Priority Data
Jul. 25, 2003 (FR) 0309141

(51) Int. Cl. E05F 11/48

(52) U.S. Cl. 49/352

(57) ABSTRACT

A housing for a window regulator actuating device includes a receptacle having a wall with a tongue, a cover having a groove that cooperates with the tongue and a securing element, such as a screw, that secures the cover onto the receptacle. The housing is fixed onto a support wall of a vehicle door.

### REFERENCE TO RELATED APPLICATIONS

This application claims priority to French Patent Application FR 03 09 141 filed on Jul. 25, 2003.

### TECHNICAL FIELD

The present invention relates to a device that actuates the opening of a window or openable member, and more specifically relates to a housing in which the device is arranged.

### BACKGROUND OF THE INVENTION

A window opening actuating device opens and closes a window glass in a vehicle, such as a sun roof, a door window or a rear quarter panel window. The device can also be used for electrically-operated sliding doors.

The term “window regulator actuating device” designates an actuating device that performs an opening action for an openable member, such as a door or rear quarter panel window glass, a roof glass, or other openable member, such as a door or sun roof.

A door window regulator is disclosed in U.S. Pat. No. 6,141,910. The door window regulator includes a motor that drives a drum by a gear unit. The drum drives a cable that moves a window glass along a rail.

The gear unit and the drum are generally arranged in a housing that protects the window regulator and makes handling easier. The housing also contains the motor and an electronic unit or includes openings for a modular assembly including these elements. Such a housing is disclosed in U.S. Pat. No. 6,141,910. The housing is closed by three screws arranged around walls surrounding the drum of the window regulator. The three screws ensure sufficient closing over the whole periphery of the housing.

The window regulator is arranged in the actual vehicle openable member, such as a vehicle door, a roof zone of the vehicle, or in a bodywork element, such as a vehicle rear quarter panel. The description which follows relates to a vehicle openable member and can also apply to a rear quarter panel.

A support wall separates two zones in the vehicle openable member. A wet zone toward the outside of the vehicle is defined by the bodywork and the support wall, and a dry zone toward the inside of the vehicle is defined by the door trim and the support wall.

The vehicle openable member, such as a door, contains numerous electronic and mechanical elements, including a window regulating device, a lock, audio equipment and other equipment. These elements are arranged in the openable member and are generally fixed on the support wall, either on the dry zone side (the electronic elements) or on the wet zone side (the guide rails and the window actuating cable).

In a window regulating device, the drive motor and the electronic unit are preferably arranged in the dry zone, and the drum and the drive cable of the window glass are preferably arranged in the wet zone. This arrangement of the window regulating device is described in U.S. Pat. No. 6,427,386.

Therefore, it is necessary to provide two parts to the window regulating device, i.e., the drum, the cable with the rails, and the window glass arranged in the wet zone and the motor that drives the drum of the window regulator arranged in the dry zone.

The constraint on the arrangement between the window regulator elements complicates the mounting of the housing of the window regulator actuating device in the openable member.

### SUMMARY OF THE INVENTION

The present invention simplifies the assembly of a housing for a window regulator actuating device and the mounting of the housing in a vehicle openable member.

The present invention provides a housing for an actuating device of a window regulator or a vehicle openable member including a receptacle having a wall with a tongue, a cover having a groove adapted to cooperate with the tongue, and an element that secures the cover onto the receptacle.

According to one embodiment, the securing element holds the tongue inserted in the groove, and under tension. In another embodiment, the receptacle includes a bore and the securing element includes a screw that penetrates into the bore.

According to one embodiment, the cover includes a tongue, and the securing element is screwed through the tongue. According to another embodiment, the cover includes a bore and the securing element is a screw that penetrates into the bore.

According to one embodiment, the securing element includes a shoulder that defines a centering section and a screwing section, and the centering section has a larger diameter than the screwing section.

The invention also relates to a vehicle openable member including a dry zone and a wet zone separated by a support wall and a housing for an actuating device of a window regulator or the openable member.

According to one embodiment, the housing is fixed onto the support wall in the wet zone. According to another embodiment, the receptacle of the housing is arranged in the dry zone, the cover of the housing is arranged in the wet zone, and the support wall has an opening that allows a groove of the cover to pass into the dry zone.

According to one embodiment, the securing element passes through the support wall. According to another embodiment, the housing includes a bore that receives the securing element to secure the housing to the support wall.

The invention also provides a method for securing a housing for an actuating device of a window regulator or vehicle openable member. The method includes the steps of inserting a tongue of a receptacle containing the window regulator actuating device into a groove of a cover and securing the cover onto the receptacle to hold the tongue in the groove under tension.

According to one embodiment, the securing step is carried out by a single securing element that secures the cover onto the receptacle. According to another embodiment, the securing element centers the cover and the receptacle. The securing element includes a shoulder defining a centering section and a screwing section, where the centering section has a larger diameter than the screwing section.

According to one embodiment, the housing is fixed in a vehicle openable member including a dry zone and a wet zone separated by a wall. The method includes the step of partially fixing the cover onto the wall in the wet zone before the step of inserting the tongue of the receptacle into the groove of the cover.

Other characteristics and advantages of the invention will become apparent on reading the following detailed description of the embodiments of the invention, given by way of example only, and with reference to the drawings.

### BRIEF DESCRIPTION OF THE DRAWINGS

FIG. 1 shows a housing for a window regulator actuating device of the present invention in the open state;

FIG. 2 shows the housing of FIG. 1 with the cover fitting onto the receptacle;

FIG. 3 shows the housing of FIG. 1 in the closed state;

FIGS. 4a to 4c show diagrammatic views of an embodiment of the securing element;

FIG. 5 shows a support wall including the cover of the housing fixed in the wet zone; and

FIG. 6 shows the support wall of FIG. 5 with the receptacle of the housing fixed in the dry zone.

### DETAILED DESCRIPTION OF PREFERRED EMBODIMENTS

A housing for an actuating device of a window regulator or vehicle openable member includes a receptacle and a cover. The receptacle has lateral walls including an outwardly projecting tongue. The cover includes a groove that cooperates with the tongue when the housing is closed. A securing element secures the cover onto the receptacle when the tongue of the receptacle is inserted into the groove of the cover.

The housing fixes the cover onto the receptacle with a single securing element, such as a screw, that holds the tongue inserted in the groove under tension, simplifying the closing of the housing.

The housing can be arranged on both sides of a support wall of the vehicle openable member. The receptacle, which cntains some of the elements of the window regulating device, can be arranged in the dry zone, and the cover covering other elements of the winder-regulating device can be arranged in the wet zone. The securing of the cover onto the receptacle is carried out through the support wall.

The housing for the window regulator actuating device will be described with reference to FIGS. 1, 2 and 3 which illustrate, respectively, the housing in an open state, during closing and in a closed state.

The housing includes a receptacle 10 and a cover 20. The receptacle 10 contains some of the elements of a window regulating device, such as a drum 5, a gear unit (not shown), and a drive shaft 6. The housing can contain or be assembled in a modular manner with a motor 7 and an electronic unit 8. The motor 7 engages with the gear unit connected to the drum 5 by a worm.

The receptacle 10 is generally made of plastic, and the cover 20 is made of either plastic or metal. The receptacle 10 includes lateral walls 11, for example a circular wall in the shape of the drum 5. However, the receptacle 10 can have other suitable shapes. The lateral wall 11 has a tongue 12 that projects towards the outside of the receptacle 10. The tongue 12 can be made in a single piece with the receptacle 10, such as from molded plastic.

The cover 20 includes a groove 22 formed in the plane of the cover 20. The groove 22 has dimensions complementary with the tongue 12, i.e. the tongue 12 must be able to be inserted into the groove 22 when the cover 20 closes the receptacle 10.

The cover 20 can also include a tongue 25 to facilitate the removal of the cover 20 and the positioning of the cover 20 on the receptacle 10. The tongue 25 can also facilitate the swinging movement of the cover 20 in order to insert the tongue 12 of the receptacle 10 into the groove 22 of the cover 20.

The cover 20 can have side walls 21, for example, a circular wall in the shape of the drum 5 projecting from the receptacle 10. However, if the lateral walls 11 of the receptacle 10 include the entire drum 5, the cover 20 can be flat. The cover 20 can also include cable routers 23 which guide the movement of a cable (not represented) which actuates a window glass or openable member.

A securing element 30 secures the cover 20 onto the receptacle 10. The securing element 30 is capable of holding the tongue 12 under tension when the tongue 12 is inserted into the groove 22 of the cover 20. For example, the securing element 30 can be arranged on the wall of the housing opposite to the assembly location of the tongue 12 in the groove 22.

In one example, the securing element 30 is a screw. The receptacle 10 includes a bore 13, and the cover 20 includes a screw hole 26 which can be arranged on the tongue 25 of the cover 20, if appropriate. The screw hole 26 and the top of the bore 13 can be countersunk so that each has a conical pilot collar to ensure the centering of the screw hole 26 of the cover 20 with the bore 13 of the receptacle 10.

The cover 20 is also centered by the connection between the drive shaft 6 and a pilot collar 27 provided in the cover 20 facing the drive shaft 6. Control of the distance between the drive shaft 6 and the bore 13 of the securing element 30 guarantees proper gear meshing of the worm of the motor 7 with the gear unit connected to the drum 5.

A description now follows of the steps of closing the housing according to the invention. In FIG. 1, the receptacle 10 includes the window regulating elements to be arranged in the housing. The height of the drum 5 can exceed the height of the lateral walls 11 of the receptacle 10. The cover 20 is also optionally provided with side walls 21 having a height sufficient to cover the drum 5 projecting from the receptacle 10.

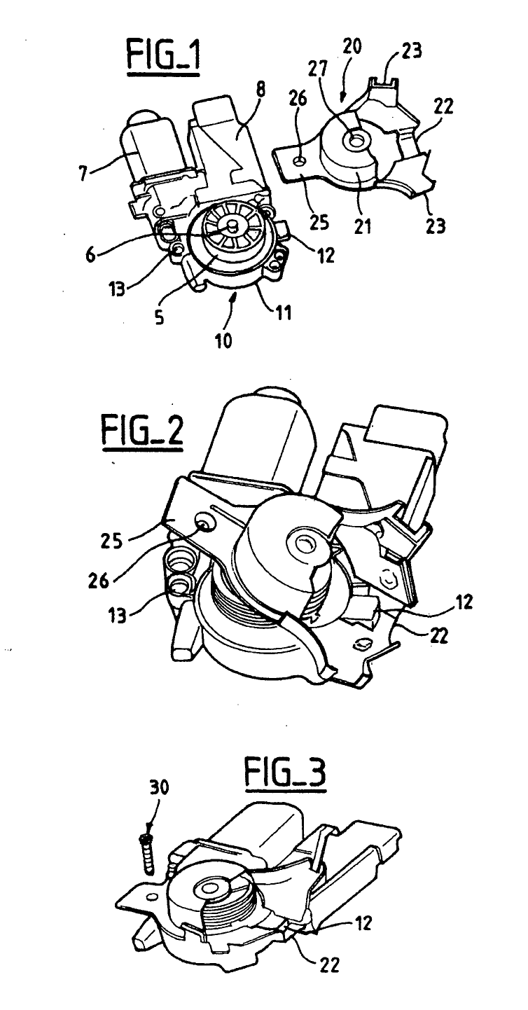

As shown in FIG. 2, when closing the housing, the cover 20 is positioned over the receptacle 10. For this purpose, the cover 20 is inclined in order to slide the tongue 12 of the receptacle 10 in the groove 22 of the cover 20. When the tongue 12 has been inserted into the groove 22, the cover 20 is closed over the receptacle 10, optionally using the tongue 25 of the cover 20. The closing of the cover 20 over the receptacle 10 holds the tongue 12 in the groove 22 under tension.

As shown in FIG. 3, the cover 20 is then secured onto the receptacle 10 by the securing element 30, such as a screw. The securing element 30 passes through the tongue 25 of the cover 20 via the screw hole 26 and penetrates into the bore 13 in the receptacle 10. A conical pilot collar encircling the screw hole 26 and corresponding to a conical pilot collar of the bore 13 and a pilot collar 27 of the cover 20 facing the drive shaft 6 centers the cover 20 with respect to the receptacle 10. The securing element 30 holds the tongue 12 of the receptacle 10 in the groove 22 of the cover 20 under tension. The housing is thus closed by a single securing element 30 and by the cooperation of the tongue 12 in the groove 22.

As shown in FIG. 3, the securing element 30 secures the cover 20 onto the receptacle 10, but the receptacle 10 can also be secured onto the cover 20, with the cover 20 having a bore and the receptacle 10 having a screw hole.

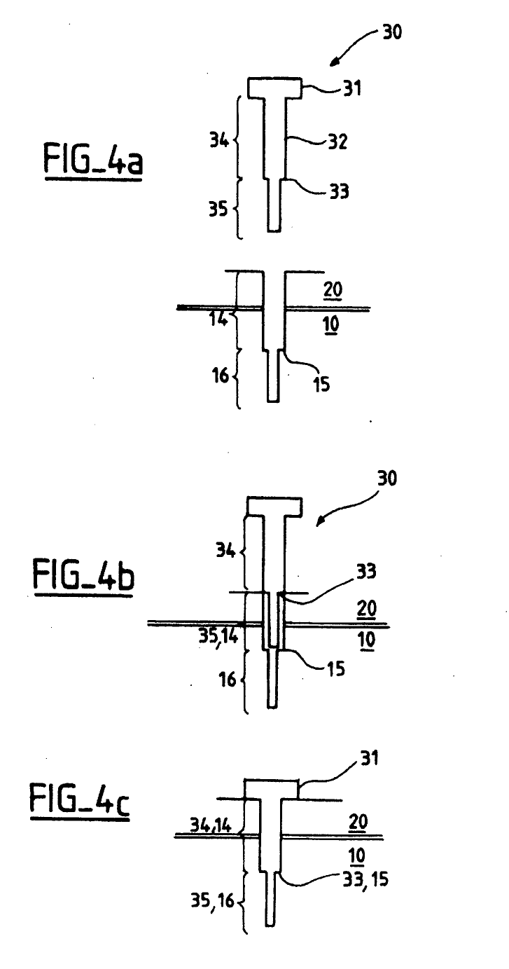

FIGS. 4a to 4c diagrammatically represent another embodiment of the securing element 30. The securing element 30 includes a head 31, a stem 32 having a shoulder 33 which defines an upper section 34 starting from the head 31, and a lower section 35. The upper section 34 has a larger diameter than the lower section 35.

The bore 13 is divided between the cover 20 and the receptacle 10 and includes an upper section 14 shared between the cover 20 and the receptacle 10 that starts at the opening and terminates at a shoulder 15 which defines a lower section 16 (FIG. 4a). The lower section 16 is entirely in the receptacle 10 (FIG. 4) or in the cover 20.

The upper sections 14 and 34 function as centering sections. The lower section 35 of the securing element 30 penetrates into the bore 13, which has a smaller diameter than the diameter of the upper section 14 of the bore 13 (FIG. 4b). The initial centering does not therefore have to be perfect because the centering is later carried out by the securing element 30.

The lower section 35 of the securing element 30 stops against the shoulder 15 of the bore 13 (FIG. 4b). The upper section 34 of the securing element 30 then ensures the centering of the upper section 14 of the bores of the cover 20 and of the receptacle 10.

The lower section 35 functions as a screwing section. The upper section 34 of the securing element 30 penetrates into the bores of the cover 20 and the receptacle 10 before the lower section 35 of the securing element 30 penetrates into the lower section 16 of the bore 13. The cover 20 and the receptacle 10 are thus centered before screwing begins.

As the head 31 of the securing element 30 is pushed further forward (FIG. 4c), and the lower section 35 of the securing element 30 penetrates into the lower section 16 of the bore 13 as far as the stop for the head 31 on the support surface of the cover 20, receptacle 10 or motor (depending on the embodiments). Optionally, the lower sections 16 and 35 can be equipped with additional screw threads on the inside of the bore 13 and on the outside of the securing element 30, but the reduction in the diameter of the lower section 16 alone is sufficient to ensure that the securing element 30 is properly held in the bore 13.

It should be understood that the lower section 16 can be arranged in the receptacle 10 as illustrated in FIGS. 4a to 4c or can be arranged in the cover 20, for example, at the tongue 25.

The housing for the window regulator device according to the present invention is placed in a door, a rear quarter panel or a sun roof of a vehicle. As previously described, a vehicle openable member or rear quarter panel has a dry zone and a wet zone separated by a support wall. The housing is fixed onto the support wall.

According to a first embodiment, the housing is fastened onto the support wall 100 in the wet zone, i.e. in the zone including the window glass and the cable for actuating movement of the window glass. The closed housing can be screwed, clipped or crimped onto the support wall 100 or fastened by any other appropriate method.

The cover 20 can include a bore or several bores (not represented), for example, on the tongue 25 and/or alongside the cable routers 23, to secure the housing of the device onto the support wall 100, regardless of the shape of the motor 7. The bores that receive the securing elements for securing the housing to the support wall 100 can also be arranged in the receptacle 10.

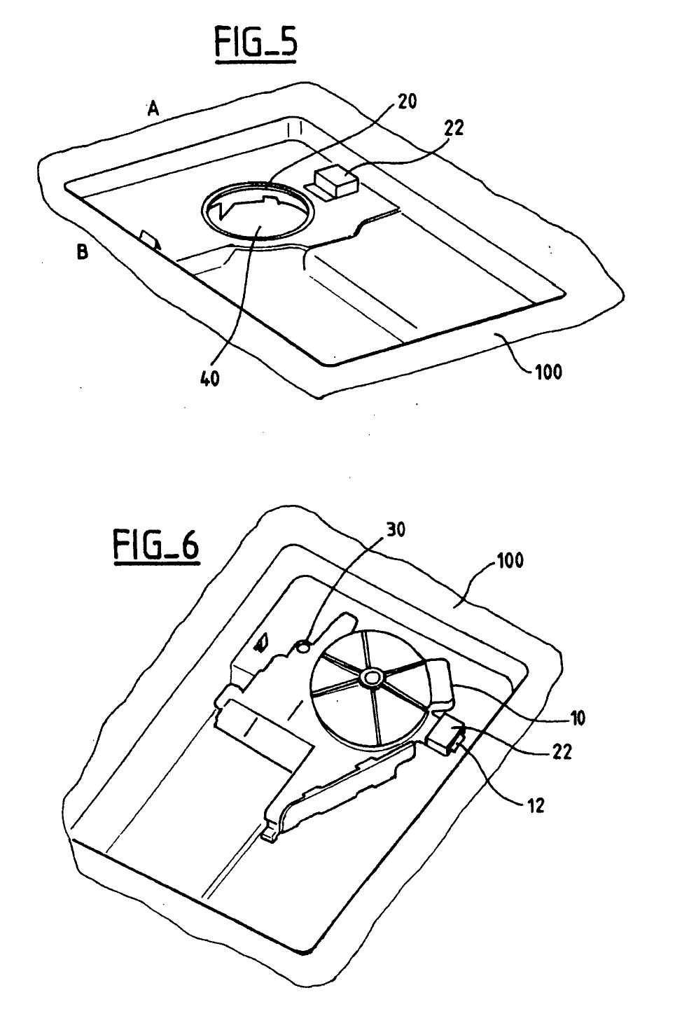

According to another embodiment, illustrated diagrammatically in FIGS. 5 and 6, the housing can be fixed on both sides of the suppport wall 100 that separates the dry zone A from the wet zone B.

The cover 20 is arranged in the wet zone B and fastened to the support wall 100, for example, by clipping. The support wall 100 includes an opening which allows the groove 22 of the cover 20 to pass into the dry zone A. The receptacle 10 is fixed onto the support wall 100 in the dry zone A, and the tongue 12 penetrates into the groove 22 and projects into the dry zone A. The securing element 30 passes through the support wall 100 either via a hole pre-formed in the support wall 100 or by piercing the wall in situ during securing.

The cover 20 is fixed around an opening 40 in the support wall 100. According to this embodiment, the cover 20 is generally fixed with the drive drum 5 contained in the cover 20, and the drum 5 is connected to the cable to move the window glass. However, the drum 5 is not represented in FIG. 5 to allow the opening 40 in the support wall 100 to be seen.

The receptacle 10 contains a gear unit that drives the drum 5 by a motor. The gear unit shaft will thus be connected to the drum 5 from the dry zone A through the opening 40 of the support wall 100. The receptacle 10 thus includes a sealing joint.

Thus, a housing for a window regulator device is obtained that is fixed onto a support wall 100 of an vehicle openable member, with the drum 5 arranged in the wet zone B and the gear unit driven by the motor arranged in the dry zone A. The motor connected to the gear unit will thus be arranged in the dry zone A, facilitating access to the motor and to an electronic unit in case of breakdown or replacement.

According to this embodiment, the housing can also be closed and fixed to the support wall 100 by the same operation.

The invention also provides a method for securing a housing according to the invention. The method includes the steps of providing a receptacle 10 containing a device for actuating the window regulator and a cover 20, inserting a tongue 12 of the receptacle 10 into a groove 22 of the cover 20 and securing the cover 20 onto the receptacle 10 to hold the tongue 12 inserted in the groove 22 under tension.

The method according to the present invention can include partially fixing the cover 20 onto a support wall 100 in the wet zone B before inserting the tongue 12 of the receptacle in the groove 22 of the cover 20. The partial fixing can be carried out by screwing or clipping the cover 20 onto the support wall 100.

When the tongue 12 is inserted into the groove 22 of the cover 20, the housing can be closed and finally fixed onto the support wall 100 of the openable member. The securing step can be carried out by a single securing element 30, such as a screw, fixed onto a tongue 25 of the cover 20 that penetrates into a bore 13 of the receptacle 10. The securing step can also center the cover 20 with respect to the receptacle 10, for example, by using a securing element as described with reference to FIGS. 4a to 4c.

Of course, the present invention is not limited to the embodiments described by way of example, thus the shapes of the housing and its location can vary as a function of the elements contained in the housing and their arrangement in the dry and wet zones of an openable member or rear quarter panel of a vehicle.

The foregoing description is only exemplary of the principles of the invention. Many modifications and variations of the present invention are possible in light of the above teachings. The preferred embodiments of this invention have been disclosed, however, so that one of ordinary skill in the art would recognize that certain modifications would come within the scope of this invention. It is, therefore, to be understood that within the scope of the appended claims, the invention may be practiced otherwise than as specifically described. For that reason the following claims should be studied to determine the true scope and content of this invention.

1. A housing for an actuating device of a vehicle window regulator or an openable member, the housing comprising:
a receptacle including a wall having a tongue;
a cover including a groove that cooperates with the tongue; and
a securing element to secure the cover onto the receptacle.

2. The housing according to claim 1, wherein the tongue is inserted into the groove and the securing element holds the tongue under tension.

3. The housing according to claim 1, wherein the receptacle includes a bore, and wherein the securing element is a screw that penetrates into the bore.

4. The housing according to claim 3, wherein the cover includes a second tongue and the securing element is screwed through the second tongue.

5. The housing according to claim 1, wherein the cover includes a bore and the securing element is a screw that penetrates into the bore.

6. The housing according to claim 1, wherein the securing element includes a shoulder defining a centering section and a screwing section, wherein the centering section has a centering section diameter and the screwing section has a screwing section diameter that is smaller than the centering section diameter.

7. A vehicle openable member comprising:
a dry zone;
a wet zone;
a support wall separating the wet zone from the dry zone; and
a housing for an actuating device of a window regulator or openable member, the housing comprising:
a receptacle including a wall having a tongue;
a cover including a groove that cooperates with the tongue; and
a securing element to secure the cover onto the receptacle.

8. The vehicle openable member according to claim 7, wherein the housing is fixed on the support wall in the wet zone.

9. The vehicle openable member according to claim 7, wherein the receptacle of the housing is arranged in the dry zone, the cover of the housing is arranged in the wet zone, and the support wall includes an opening that allows the groove of the cover to enter into the dry zone.

10. The vehicle openable member according to claim 9, wherein the securing element passes through the support wall.

11. The vehicle openable member according to claim 7, wherein the housing includes a bore that receives the securing element to secure the housing to the support wall.

12. A method for securing a housing of an actuating device of a vehicle window regulator or an openable member, the housing including a receptacle having a wall with a tongue, a cover having a groove that cooperates with the tongue, and a securing element to secure the cover onto the receptacle, the method comprising the steps of:
inserting the tongue of the receptacle into the groove of the cover; and
securing the cover onto the receptacle to hold the tongue under tension.

13. The method according to claim 12, wherein the securing element is a single securing element and the step of securing utilizes the single securing element.

14. The method according to claim 12, wherein the step of securing further comprises centering the cover and the receptacle by using the securing element, wherein the securing element includes a shoulder defining a centering section and a screwing section, and wherein the centering section has a centering section diameter and the screwing section has a screwing section diameter that is smaller than the centering section diameter.

15. The method according to claim 12, wherein the housing of the actuating device is disposed in a vehicle openable member having a dry zone, a wet zone and a support wall separating the dry zone and the wet zone, and wherein the method further comprises the step of partially fixing the cover onto the support wall in the wet zone before the step of inserting the tongue of the receptacle into the groove of the cover.
